(19) United States
(12) Patent Application Publication
(10) Pub. No.: US 2004/0196260 A1
(43) Pub. Date: Oct. 7, 2004

(54) Computer cursor control joystick and its control method

(76) Inventors: Teng-Chang Lin, Yunlin Hsien (TW); Jian-Wang Chen, Shinjuang City (TW)

Correspondence Address: BIRCH STEWART KOLASCH & BIRCH, PO BOX 747, FALLS CHURCH, VA, 22040-0747, US

(21) Appl. No.: 10/402,994

(22) Filed: Apr. 1, 2003

(51) Int. Cl. G09G 5/08

(52) U.S. Cl. 345/161

(57) ABSTRACT

The present invention discloses a method of controlling a computer cursor by a joystick, which uses at least one X-axis variable resistor and one Y-axis variable resistor of a rotary mechanism of a joystick to produce a horizontal potential signal and a vertical potential signal to compute the potential variation of said horizontal potential signal and said vertical potential signal and produce a vector displacement signal, and then converts said vector displacement signal into a cursor control code and outputs such code to a computer, so that the cursor of the computer will generate coordinates with respect to its horizontal and vertical movements in order to achieve the purpose of controlling the movement of the computer cursor.

### BACKGROUND OF THE INVENTION

1. Field of the Invention

The present invention relates to a computer cursor control joystick and its control method, more particularly to an input device using a joystick for inputting a computer cursor and its control method.

2. Description of the Related Art

Due to the popularity of computers and the progress of related peripheral control technologies, users may use various input devices to control the computer. The common input devices are nothing better than the mouse, keyboard, and trackball, etc. For game players, joystick or joypad are indispensable. However, connecting several input devices to a computer not only occupies the space, but also uses the computer resources.

In order to save space and computer resources, the design of the prior art generally combines some control functions of the joystick or the press button. For example, the R.O.C. Patent Publication No. 452133 relating to the combination of a mouse and a joystick discloses a design of having four direction buttons on a mouse and such mouse is used as a joypad. However, there is no patent, which relates to using a joystick to control the directions of a computer cursor. The general computer joystick is divided into two types: analog joystick and digital joystick, the analog joystick rotates a X-axis variable resistor and a Y-axis variable resistor having the advantage of 360° direction-free control, but its structure and control circuit are more complicated. For example, the R.O.C. Patent Publication No. 483552 is an invention relating to an improved digital joystick structure. Although the structure and the circuit are simpler, the joystick is limited to the control by the eight directional control positions and unable to have a fine-angle control.

In view of the current inconvenience and shortcomings on the control of computer cursor direction of the present joystick, the present inventor conducted extensive studies and applied related theories to invent a computer cursor control joystick and its control method. This invention makes use of the advantage of the direction-free control of an analog joystick to control the shifting of a computer cursor and substitute the function of a computer mouse while still keeping the application function as a traditional joystick. Such design is a reasonable invention and definitely effectively overcomes the foregoing shortcomings.

### SUMMARY OF THE INVENTION

The primary objective of the present invention is to provide an improved technical measure for controlling the shifting of a computer cursor by a joystick and to overcome the shortcomings of the prior art.

The technical characteristics of the present invention resides on providing a method of controlling the computer cursor by a joystick, comprising the steps of linking at lease one rotation mechanism of a joystick respectively to a horizontal potential signal and a vertical potential signal of a X-axis variable resistor and a Y-axis variable resistor; calculating the variation of potentials of the horizontal potential signal and the vertical potential signal to produce a vector displacement signal; converting said vector displacement signal into a cursor control code and outputting said signal to a computer, so that the computer cursor producing coordinates with respect to the horizontal and vertical movements in order to achieve the effect of controlling the shifting of the computer cursor.

The secondary technical characteristic of the present invention resides on providing a method of controlling the computer cursor by a joystick, wherein a mode switch is included such that the mode is detected for setting up the cursor control mode or the game control mode and the joystick can be switched between both cursor control and game control.

Another technical characteristic of the present invention resides on providing a method of controlling the computer cursor by a joystick, wherein at least one function key is included to produce a function control signal when such function key is pressed, and mix said function control signal and said vector displacement signal for converting said signals into a function control code and outputting such code to the computer in order to achieve the effect of controlling the corresponding function of the computer.

To make it easier for our examiner to understand the technology, measures, and effects of this invention, please refer to the detailed specification together with the attached drawing for the innovative features, and performance.

### BRIEF DESCRIPTION OF THE DRAWINGS

Other features and advantages of the present invention will become apparent in the following detailed description of the preferred embodiments with reference to the accompanying drawings, in which:

FIG. 1 is a perspective diagram of the joystick of the present invention.

FIG. 2 is an illustrative diagram of the parts of the joystick structure according to the present invention.

FIG. 3 is a circuit diagram of the control circuit according to a preferred embodiment of the present invention.

FIG. 4 is an illustrative diagram of the shaking of the joystick according to the present invention.

FIG. 5 is an illustrative diagram of the circular movement of the computer cursor of the present invention.

FIG. 6 is a block diagram of the internal IC control according to the present invention.

FIG. 7 is a flow chart of the control program of the present invention.

FIG. 8 is a flow chart of the automatic speed and sensitivity control of the present invention

### DETAILED DESCRIPTION OF THE PREFERRED EMBODIMENTS

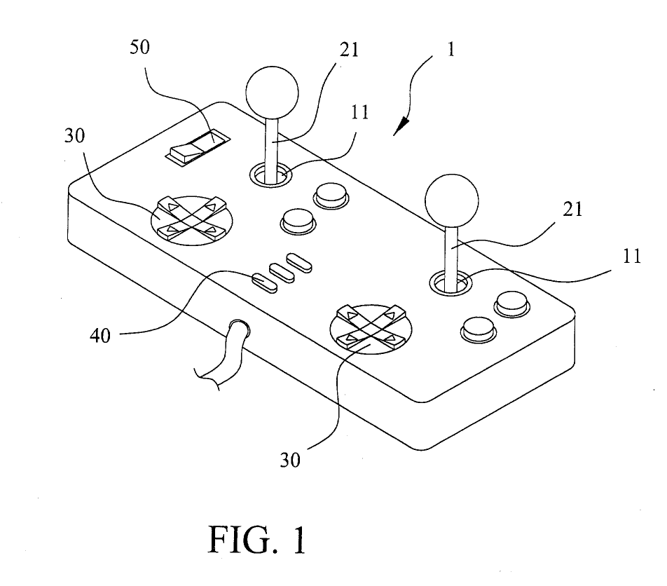

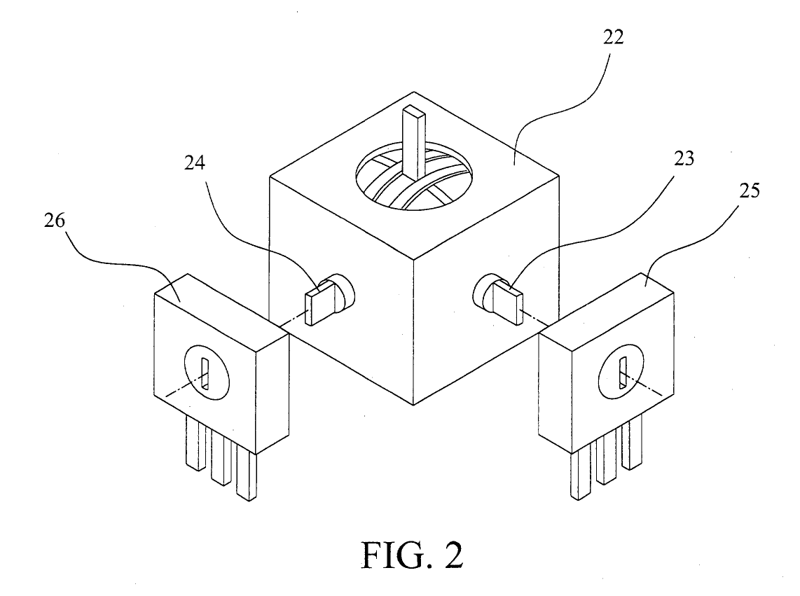

Please refer to FIG. 1 for the perspective diagram of the joystick of the present invention and FIG. 2 for the three-dimensional illustrative diagram of the joystick structure. The joystick 1 of the present invention primarily used to control the shifting of a computer cursor or the joystick for general computer games, therefore the joystick is connected to a computer by a connecting cable. In FIG. 1, the joystick 1 of the present invention comprises a housing 10, two sets of analog joystick structures 20, two sets of digital direction keyboards 30, a plurality of function keys 40, and a mode switch 50.

The structure of the analog joystick is described first. In FIG. 2, the joystick structure 20 is disposed in a housing 10, and the joystick structure 20 comprises an opening 11 penetrating through the surface of the housing 10 and being disposed at the top position corresponsive to the joystick structure 20. The joystick structure 20 comprises an operating stick 21, protruded from the circular opening 11 for users to shake the stick, and a rotation mechanism 22 is coupled to the lower end of the operating stick 21, an elastic member disposed in the rotation mechanism 22 for automatically restoring the operating stick 21 to the vertical status. Two mutually perpendicular X-axis 23 and Y-axis 24 in the rotation mechanism 22, and the X-axis 23 and the Y-axis 24 will rotate according to the shaking movement of the operating stick 21.

The joystick structure further comprises a X-axis variable resistor 25 and a Y-axis variable resistor 26, and the X-axis variable resistor 25 is linked to the rotation of the X-axis 23 for producing a horizontal potential signal by changing the value of the resistance, and the Y-axis variable resistor 26 is linked to the rotation of the Y-axis 23 for producing a vertical potential signal by changing the value of the resistance.

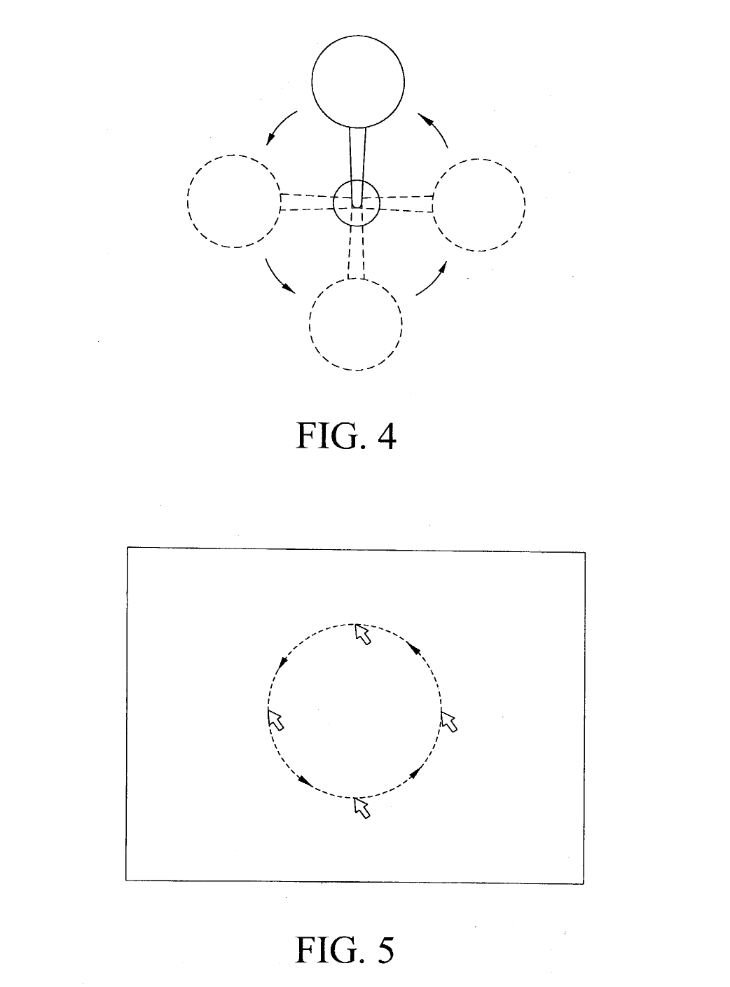

Since the digital direction keyboard 30, function key switch 40, and mode switch 50 are made of small pushbuttons, fine tune switches, or disposing switches, therefore the present invention is only described by means of circuit diagrams. Refer to FIG. 2 for the circuit diagram of an embodiment of the control circuit of the present invention. In the figure, it also shows the switches of two sets of X-axis and Y-axis variable resistors 25, 26 and two sets of direction keyboards 30. The control circuit 60 of the joystick 1 of the present invention is disposed on at least a circuit board (not shown in the figure). The circuit board is disposed in the housing 10, and the control circuit 60 has a control IC 61 electrically coupled to the X-axis variable resistor 25 and Y-axis variable resistor 26, and by receiving the horizontal potential signal and vertical potential signal, the control circuit 60 generates a cursor control code and outputs to the computer such that the computer cursor produces coordinates with respect to the horizontal and vertical shifting positions. Refer to FIGS. 4 and 5 for the illustrative diagrams of shaking the joystick for one round and its control to move the computer cursor in a circle.

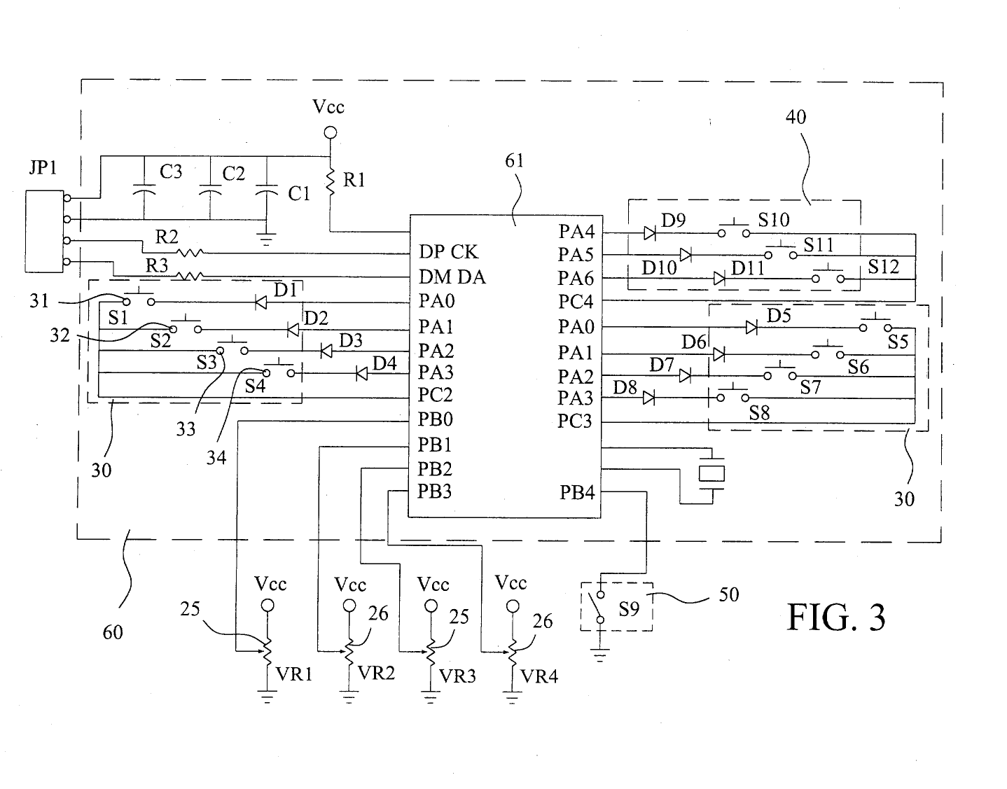

Please also refer to FIGS. 1 and 3, wherein the direction keyboard 30 is disposed on the housing 10, comprising four pushbutton switches: Up, 31, Down 32, Left 33, and Right 34 therein. By pressing any one of the Up 31, Down 32, Left 33, and Right 34 switches, or a combination of upper left 31, 33, upper right 31, 34, lower left 32, 33, or lower right 32, 34 switches, the digital shifting signals in 8 directions are produced, and the four switches 31, 32, 33, 34 are electrically coupled to a control IC 61 of said control circuit 60. The control IC 61 produces a digital shifting signal according to the pressing of the pushbutton switches 31, 32, 33, 34 and converts the digital shifting signal into a cursor control code and output such code to the computer in order to control the shifting of the computer cursor.

A plurality of the function key switches 40 are disposed on the housing 10 and electrically coupled to the control IC 61 of the control circuit 60. The control circuit 60 outputs a function control code to the computer according to the pressing of the function key switch 40 to control the computer to produce special functional movement, and the function pushbutton switch 30 must be set up in advance for such functional movement such as page scrolling, switching between application programs, and zooming in/out of the window, etc.

Since the joystick 1 of the present invention has two functions of controlling the shifting of the computer cursor and the control of computer games, therefore such mode switch 50 is used to switch between these two control modes. Such control mode switches are disposed on the housing 10, and electrically coupled to the control IC of the control circuit 60 in order to switch the setup between the cursor control mode and the game control mode.

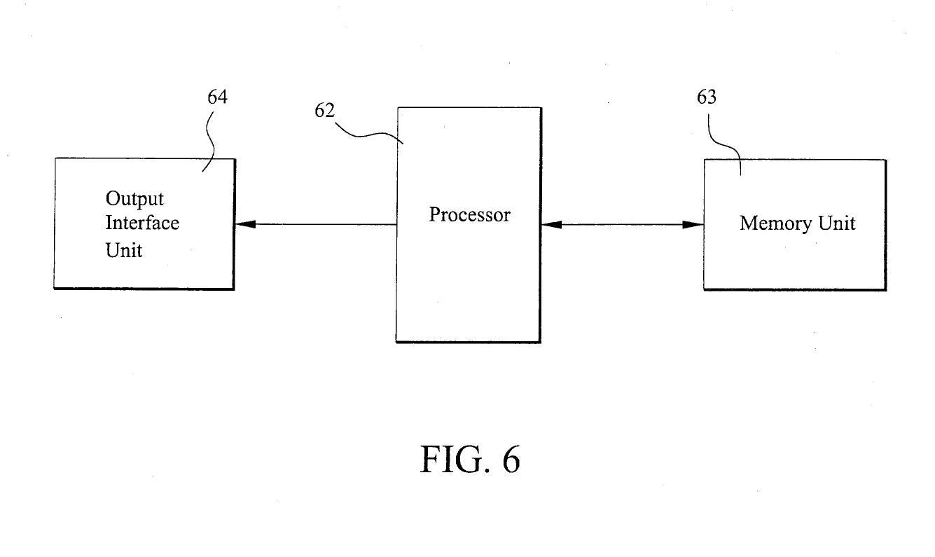

In FIG. 3, the control circuit 60 of the present invention comprises a control IC 61 serving as the control center of the joystick 1. Please refer to FIG. 6 for the block diagram of the interior of the control IC. The interior of the control IC 61 at least comprises a processor 62, a memory unit 63, and an output interface unit 64, wherein said memory unit 63 and said output interface unit 64 are coupled to the processor 62; the memory unit stores at least one control program; the control processor 62 runs the control program to compute the variation of the horizontal potential signal and the vertical potential signal, and then convert such signals into a cursor control code, and output such code to the computer from the output interface unit 64 through a connecting cable. The output interface unit 64 could be an USB interface, and the connecting cable could be an USB cable.

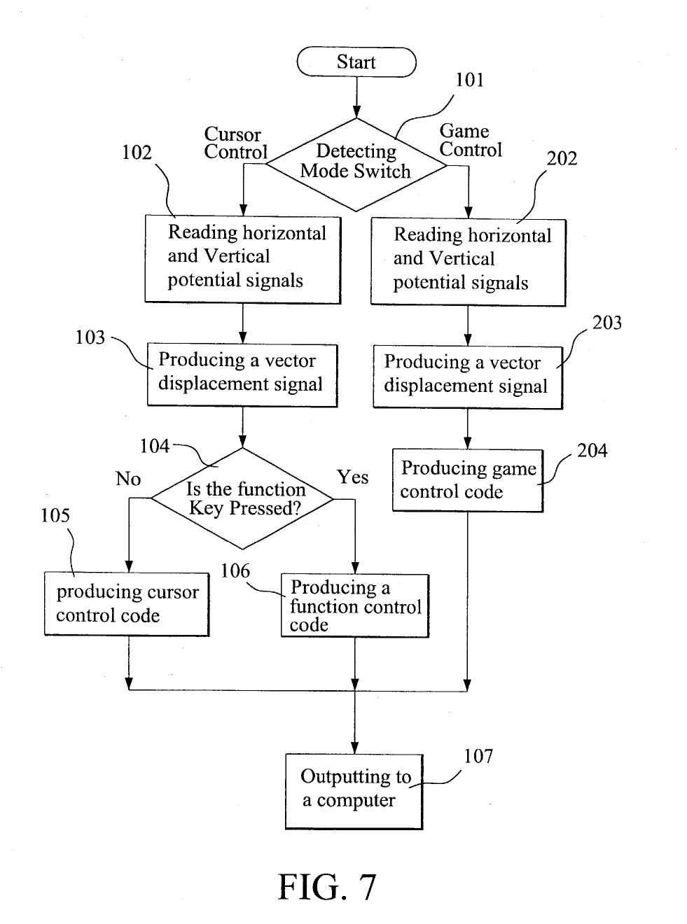

In view of the description above, the joystick of the present invention uses the rotation mechanism to link with the X-axis variable resistor 25 and the Y-axis variable resistor 26 to control the movement of the computer cursor. The flow of controlling the control program is shown in FIG. 7. The control program firstly checks if the mode switch 50 is set to the cursor control mode or to the game control mode 101. If the mode switch 50 is set to the cursor control mode, then the control program will read the horizontal potential signal produced by the X-axis variable resistor 25 and the vertical potential signal 102 produced by the Y-axis variable resistor 26 to compute the variation of the horizontal potential signal and the vertical potential signal and produce a vector displacement signal 103.

The pressing 104 of the function key switch 40 is detected; if the switch is not pressed, then the vector displacement signal is converted directly into a cursor control code 105; if the switch is pressed, then a function key control signal is produced and mixed with the vector displacement signal to convert the signals into a function control code 106. Finally, the code is outputted to the computer 107 such that the computer cursor produces coordinates with respect to the horizontal and vertical moving positions and then controls the computer to produce the corresponding functions.

However, if the mode switch 50 is set to the game control mode, then the control program will read the horizontal potential signal produced by the X-axis variable resistor 25 and the vertical potential signal 202 produced by the Y-axis variable resistor 26 to compute the variation of the horizontal potential signal and the vertical potential signal and produce a vector displacement signal 203. The signal is converted into a game control code 204 and the game control code 204 is outputted to the computer 107 to control the movement of the computer game.

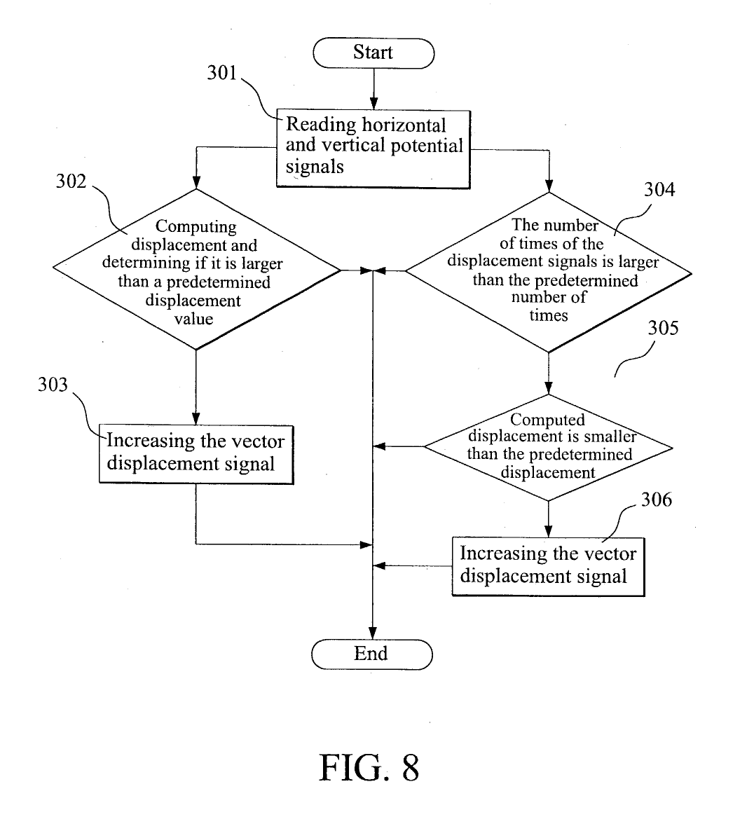

The control program of the present invention further has the functions of automatically adjusting its speed and sensitivity, and its flow is shown in FIG. 8. The method of automatically adjusting speed is to compute the vector displacement signal and determine if the displacement in a predetermined time is larger than a predetermined displacement value 302 for each time of reading the horizontal potential signal and the vertical potential signal 301. If the displacement has a value larger than the vector displacement signal 303, the speed of upward movement of the cursor is increased automatically. For instance, if the joystick 1 is controlled to move upward for a time over 1 second, then the upward distance moved by the cursor will be increased automatically, which is very similar to expediting the upward moving speed of the cursor.

As to the method of automatically adjusting the sensitivity, the number of vector displacement signals within a predetermined time for each time of reading the horizontal potential signal and the vertical potential signal is measured and determined if it is larger than a predetermined displacement value 302. If the displacement is larger than the vector displacement signal 303, the moving speed of the cursor will be increased automatically. For example, in 1 second, if the joystick is controlled to shift upward twice and only moves 0.5 cm upward each time, then the moving distance of the cursor will be increased 1 cm for each time of moving upward in order to improve the moving sensitivity.

The present invention bases on the technology described above to provide a design totally different from the prior art, and definitely can enhance the overall application value, and further complies with the patent application requirements and is submitted to the Patent and Trademark Office for review and granting of the commensurate patent rights.

While the present invention has been described in connection with what is considered the most practical and preferred embodiment by means of descriptions and drawings, it is understood that the invention is not limited to the disclosed embodiments but is intended to cover various arrangements included within the spirit and scope of the broadest interpretation and equivalent arrangements.

What is claimed is:

1. A method of controlling computer cursor by joystick, having at least a rotation mechanism of a joystick linked to a X-axis variable resistor and a Y-axis variable resistor to control the cursor movement of a computer, said method comprising the steps of:
(a) reading a horizontal signal produced by a change in resistance of a X-axis variable resistor;
(b) reading a vertical signal produced by a change in resistance of a Y-axis variable resistor;
(c) computing a variation of the horizontal said X-axis variable resistor and said Y-axis variable resistor to produce a vector displacement signal;
(d) converting said vector displacement signal into a cursor control code; and
(e) outputting said cursor control code to the computer such that the computer cursor producing coordinates with respect to the horizontal and vertical moving positions.

2. The method of controlling computer cursor by joystick of claim 1, further comprising steps before performing step (a), and said steps referring to detecting a mode switch for setting a mode selected from the collection of a cursor control mode and a game control mode; if said mode being set to the game control mode, then reading a horizontal signal produced by a change in resistance of a X-axis variable resistor; reading a vertical signal produced by a change in resistance of a Y-axis variable resistor; computing a variation of the horizontal said X-axis variable resistor and said Y-axis variable resistor to produce a vector displacement signal; converting said vector displacement signal into a game control code; and
outputting said game control code to the computer such that the computer cursor producing the corresponding game movement.

3. The method of controlling computer cursor by joystick of claim 1, further comprising steps before performing step (c), and said steps referring to detecting at least one function key switch being pressed; if said function key switch being pressed, then producing a function key control signal; mixing said function key switch control signal and said vector displacement signal to convert said signals into a function control code; outputting said function control code to the computer to control the computer to produce the corresponding functional control.

4. The method of controlling computer cursor by joystick of claim 1, further comprising steps after performing step (c), and said step refers to calculating the displacement of said vector displacement signal within a predetermined time and determining if said displacement value being larger than a predetermined displacement value; and increasing the moving speed of said cursor if said displacement value being larger than said predetermined displacement value.

5. The method of controlling computer cursor by joystick of claim 1, further comprising steps after performing step (c), and said steps referring to computing the number of times of producing said vector displacement signal within a predetermined time and determining if said number being larger than a predetermined number of times, and determining if said displacement for each time being smaller than a predetermined number of times and displacement value; and increasing said vector displacement signal to improve the sensitivity of said cursor if said number being larger than said vector signal displacement signal.

6. A computer cursor control joystick, coupled to a computer, for controlling the movement of a computer cursor, said joystick comprising:
a housing, having at least one circular opening on the top surface;
at least one rotation mechanism, being disposed at the bottom of said circular opening of said housing, and comprising two mutually perpendicular axes: a X-axis and a Y-axis;
at least one operating stick, being coupled to the top end of said rotation mechanism and protruded from said circular opening;
at least a X-axis variable resistor, being linked to the rotation of said X-axis to produce a horizontal potential signal by changing the resistance of said X-axis variable resistor;
at least a Y-axis variable resistor, being linked to the rotation of said Y-axis to produce a vertical potential signal by changing the resistance of said Y-axis variable resistor;
a control circuit, electrically coupled to said X-axis variable resistor and said Y-axis variable resistor for receiving said horizontal potential signal and said vertical potential signal to produce a cursor control code and outputting said code to a computer such that the computer producing coordinates with respect to the horizontal and vertical moving positions of said computer cursor.

7. The computer cursor control joystick of claim 6, further comprising: a plurality of function key switches, disposed on said housing and electrically coupled to said control circuit, and said control circuit producing a function control code by pressing said function key switch and then outputting said code to said computer.

8. The computer cursor control joystick of claim 6, further comprising: at least one direction keyboard, disposed on said housing, and comprising four pushbutton single switches: Up, Down, Left, and Right switches and four combinational switches: Upper Left, Upper Right, Lower Left, and Lower Right switches to produce eight cursor control codes and said codes being outputted to said computer.

9. The computer cursor control joystick of claim 6, further comprising:
a mode switch, disposed on said housing and electrically coupled to said control circuit for switching the setup between the cursor control mode and the game control mode.

10. The computer cursor control joystick of claim 6, wherein said control circuit comprising:
a memory unit, storing at least a control program therein;
a processor, coupled to said memory unit, for running said control program to compute the variation of said horizontal potential signal and said vertical potential signal and produce a cursor control code; and
an output interface unit, coupled to said processor, and electrically coupled to said computer by a connecting cable for outputting said cursor control code to said computer.

11. The computer cursor control joystick of claim 10, wherein said output interface unit is a USB interface, and said connecting cable is a USB connecting cable.
